(19) United States
(12) Patent Application Publication
(10) Pub. No.: US 2026/0039505 A1
(43) Pub. Date: Feb. 5, 2026

(54) METHOD, APPARATUS AND DEVICE FOR PERFORMING HARDWARE ACCELERATION ON LAYER 2 TUNNELING PROTOCOL MESSAGE, AND STORAGE MEDIUM

(71) Applicant: SANECHIPS TECHNOLOGY CO., LTD., Shenzhen, Guangdong (CN)

(72) Inventors: Jiayu DU, Shenzhen, Guangdong (CN); Xuesong SHI, Shenzhen, Guangdong (CN); Fushan SUN, Shenzhen, Guangdong (CN)

(21) Appl. No.: 19/125,780

(22) PCT Filed: Sep. 13, 2023
(86) PCT No.: PCT/CN2023/118546

§ 371 Date: Apr. 30, 2025

(30) Foreign Application Priority Data
Nov. 4, 2022 (CN) 202211378929.9

(51) Int. Cl. H04L 12/46; H04L 69/22; H04L 69/30

(52) U.S. Cl. CPC H04L 12/4633; H04L 69/22; H04L 69/30

(57) ABSTRACT

Disclosed are a method, an apparatus and a device for performing hardware acceleration on an L2TP message and a storage medium. The method includes: determining whether the current message requiring hardware acceleration is an L2TP type message according to a first matching rule, the first matching rule is a protocol stack configuration information only used to identify the header type of the current message; selecting a corresponding acceleration processing strategy according to the determination result, when the determination result is an plain message of a non-L2TP type, performing acceleration processing on the plain message according to a preset protocol stack standard, and when the determination result is an L2TP message, performing acceleration processing on the L2TP message according to a second matching rule, the second matching rule is protocol stack configuration information for matching inner layer information of the L2TP message.

### CROSS-REFERENCE TO RELATED APPLICATIONS

This application is a U.S. National Phase application of International Application No. PCT/CN2023/118546, filed on Sep. 13, 2023, which claims priority to Chinese Patent Application No. 202211378929.9, filed with the China National Intellectual Property Administration on Nov. 4, 2022.

### TECHNICAL FIELD

The present application relates to, but is not limited to, the field of passive optical network (PON) chips, and in particular to a method, an apparatus and a device for performing hardware acceleration on a layer 2 tunneling protocol (L2TP) message, and a storage medium.

### BACKGROUND

L2TP is a virtual tunnel protocol, usually used in virtual private networks. Usually, L2TP messages have a distinct composition compared to plain messages. For example, after the header of L2TP messages, there will be inner-layer PPP, inner-layer IP, and inner-layer UDP, and these contents will be treated as message contents without parsing in the current message parsing method.

In the current solution, these encapsulated L2TP messages are directly passed to the protocol stack for processing. Therefore, hardware acceleration of L2TP messages cannot be achieved, resulting in lower processing performance for L2TP messages compared to plain messages.

### SUMMARY

In view of this, embodiments of the present application provide a method, an apparatus and a device for performing hardware acceleration on an L2TP message, and a storage medium, aiming to solve the technical problem of the difficulty in performing hardware acceleration on the L2TP message.

An embodiment of the present application provides a method for performing hardware acceleration on an L2TP message, including:
determining whether a current message requiring hardware acceleration is an L2TP type message according to a first matching rule, the first matching rule is protocol stack configuration information used only to identify a header type of the current message; and
selecting a corresponding acceleration processing strategy according to a determination result, in response to that the determination result is a plain message of a non-L2TP type, performing acceleration processing on the plain message according to a preset protocol stack standard, and in response to that the determination result is an L2TP message, performing acceleration processing on the L2TP message according to a second matching rule, the second matching rule is protocol stack configuration information for matching inner layer information of the L2TP message.

The embodiment of the present application further provides an apparatus for performing hardware acceleration on a L2TP message, including:
an identification module configured to determine whether a current message requiring hardware acceleration is an L2TP type message according to a first matching rule, wherein the first matching rule is protocol stack configuration information used only to identify the header type of the current message; and
an acceleration module configured to select a corresponding acceleration processing strategy according to a determination result, perform acceleration processing on a plain message of a non-L2TP type according to a preset protocol stack standard when the determination result is the plain message, and perform acceleration processing on an L2TP message according to a second matching rule when the determination result is the L2TP message, the second matching rule is protocol stack configuration information for matching inner layer information of the L2TP message.

The embodiment of the present application further provides a device for performing hardware acceleration on a L2TP message. The device for performing hardware acceleration on the L2TP message is a physical node device and includes a memory, a processor, and a program for performing hardware acceleration on the L2TP message stored in the memory and executable on the processor. When the program for performing hardware acceleration on the L2TP message is executed by the processor, the method for performing hardware acceleration on the L2TP message as described above is implemented.

To achieve the above objectives, the embodiments of the present application further provide a computer-readable storage medium. A program for performing hardware acceleration on a L2TP message is stored on the computer-readable storage medium, and when the program for performing hardware acceleration on the L2TP message is executed by a processor, the method for performing hardware acceleration on the L2TP message as described above is implemented.

### BRIEF DESCRIPTION OF THE DRAWINGS

FIG. 1 is a flowchart of a method for performing hardware acceleration on an L2TP message according to an embodiment of the present application.

FIG. 2 is a flowchart of hardware processing of the method for performing hardware acceleration on the L2TP message according to an embodiment of the present application.

FIG. 3 is a schematic structural diagram of a hardware operating environment according to an embodiment of the present application.

### DETAILED DESCRIPTION OF THE EMBODIMENTS

It should be understood that the specific embodiments described herein are only used to explain the present application and are not used to limit the present application.

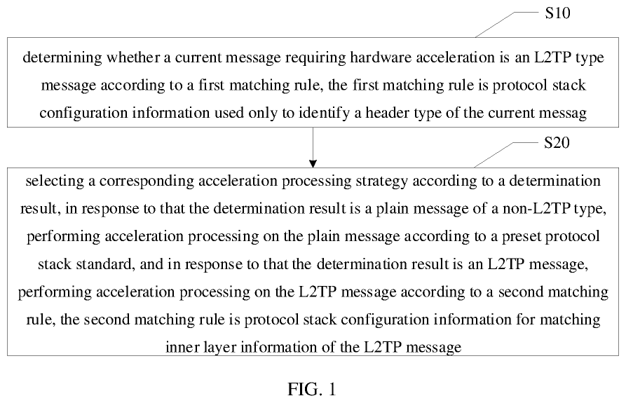

The embodiment of the present application provides a method for performing hardware acceleration on an L2TP message. Referring to FIG. 1, the method for performing hardware acceleration on the L2TP message according to the embodiment of the present application includes:
step S10, determining whether the current message requiring hardware acceleration is an L2TP type message according to a first matching rule, the first matching rule is protocol stack configuration information only used to identify the header type of the current message;
step S20, selecting a corresponding acceleration processing strategy according to a determination result, when the determination result is a plain message of a non-L2TP type, acceleration processing is performed on the plain message according to a preset protocol stack standard, and when the determination result is an L2TP message, the acceleration processing is performed on the L2TP message according to a second matching rule. The second matching rule is protocol stack configuration information for matching inner layer information of the L2TP message.

This embodiment aims to perform hardware acceleration on the L2TP message and improve the processing performance of the L2TP message.

The specific application scenario of this embodiment will be described below.

The format of L2TP message is: MAC header+[PPPOE header]+[PPP header]+IP header+UDP header+L2TP header+inner-layer PPP header+inner-layer IP header+inner-layer UDP header+message content, while the format of normal messages is: MAC header+[PPPOE header]+[PPP header]+IP header+UDP header+message content. Therefore, the existing message parsing will regard the content after the L2TP message header as the message content and will not parse it.

In view of the above reasons, in the current processing scheme, the encapsulated message of L2TP is directly given to the protocol stack for processing. Therefore, it is impossible to achieve hardware acceleration of L2TP message, resulting in the processing performance of L2TP message being lower than that of plain message.

If the L2TP protocol identification part is added to the current hardware acceleration solution, L2TP protocol detection will be performed on all messages. The hardware logic of the L2TP protocol detection is complex, which will seriously affect processing performance and performance indicators of the normal message. In addition, L2TP is only a special scenario requirement of the switch. For a special scenario, the encapsulation message seriously affects the performance of the normal scenario, which is not allowed by the chip design.

As an example, the method for performing hardware acceleration on the L2TP message can be applied to a system for performing hardware acceleration on the L2TP message, which includes a camera and an apparatus for performing hardware acceleration on the L2TP message.

As an example, the L2TP message is a virtual tunnel protocol, which is usually used in a virtual private network.

As an example, the message contains rule information, and the rule information includes five-tuple information. The five-tuple information includes source IP address, destination IP address, source port, destination port, transport layer protocol/protocol number and other information.

As an example, a set of five quantities, source IP address, source port, destination IP address, destination port, and transport layer protocol, for example: 192.168.1.1 10000 TCP 121.14.88.76 80, constitutes a five-tuple. Its meaning is that a terminal with an IP address of 192.168.1.1 connects to a terminal with an IP address of 121.14.88.76 and a port of 80 through port 10000 using the TCP protocol.

As an example, hardware acceleration on the L2TP message is applied to network processor hardware.

At step S10, it is determined, according to the first matching rule, whether the current message that requires hardware acceleration is an L2TP type message, and the first matching rule is the protocol stack configuration information used only to identify the header type of the current message. As an example, the first matching rule refers to the configuration information used to identify the header type of the message, and the configuration information is allocated or issued by the kernel protocol stack. It can be understood that according to the header of the message and the first matching rule, it can be identified whether the message is an L2TP message or a non-L2TP message (plain message).

As an example, the message header refers to the service segment that starts and uniquely identifies the message, including the source port number, destination port number, sequence number and confirmation number, data offset/header length, reservation, control bit (URG, ACK, PSH, RST, SYN, FIN), window for receiving notification and other information.

As an example, the hardware used for hardware acceleration of the message can be network processor hardware.

As an example, if the current message received is a message that requires hardware acceleration processing, the first matching rule is obtained, and it is identified through the first matching rule whether the current message is the L2TP message. The identification determines that the current message is subjected to different hardware acceleration processing.

As an example, whether the current message received requires hardware acceleration processing is determined by identifying the current message according to the preset hardware acceleration rules, and the message configured with hardware acceleration is determined to be a message that requires hardware acceleration.

As an example, the hardware acceleration rule is obtained by recording the acceleration rules or processing rules of historical messages. For example, if the historical message belongs to a hardware acceleration message or has been processed by hardware acceleration, the message rule information of the message has hardware acceleration information. Therefore, when the message is received again, it is determined that the message is a message that requires hardware acceleration. For another example, during the processing of a message not configured for hardware acceleration by the kernel protocol stack, it is identified that it is necessary for the message to generate hardware acceleration, and the kernel protocol stack issues the hardware acceleration rules for the message to the hardware. Upon receiving a message, the hardware matches the message against the hardware acceleration rules according to the hardware algorithm. If the hardware finds the same hardware acceleration rules, the message is determined to be a message that requires hardware acceleration.

At step S20, a corresponding acceleration processing strategy is selected according to the determination result, when the determination result is a plain message of a non-L2TP type, the acceleration processing is performed on the plain message according to the preset protocol stack standard, and when the determination result is an L2TP message, the acceleration processing is performed on the L2TP message according to the second matching rule. The second matching rule is protocol stack configuration information for matching the inner layer information of the L2TP message.

As an example, the acceleration processing strategy includes how the hardware processes the message according to the protocol stack standard of the kernel protocol stack, and also includes how the hardware matches the inner layer information of the message according to the second matching rule and accelerates the processing.

As an example, the second matching rule is configured to match the protocol stack configuration information of the inner layer information of the L2TP message. It can be understood that the first matching rule matches the header of the current message. In the L2TP scenario, the same outer layer rule (first matching rule) may correspond to different inner layer matching rules (second matching rule) and different forwarding schemes. Therefore, the second matching rule can match the corresponding hardware acceleration rule according to the inner layer information of the L2TP message, and the hardware acceleration rule is configured to modify and forward the L2TP message.

As an example, the kernel protocol stack must ensure that the same outer layer rule is not repeatedly set in the hardware. Therefore, if multiple inner layer matching methods correspond to the same outer layer matching rule, the kernel protocol stack needs to ensure that the outer layer rule is deleted at the same time as the last inner layer matching rule is deleted.

As an example, the selecting the corresponding acceleration processing strategy according to the determination result includes:
step S21, in response to that the determination result is a plain message of non-L2TP type, obtaining the protocol stack standard configured in the hardware; and
step S22, modifying and forwarding the plain message according to the protocol stack standard.

As an example, if the current message that needs hardware acceleration is determined to be a non-L2TP type message, that is, a plain message, according to the first matching rule, the protocol stack standard configured in the hardware is obtained, and the plain message is modified and forwarded according to the protocol stack standard.

As an example, the protocol stack standard is configured with packet modification information and message egress information, and the plain message is modified through the packet modification information, and the modified message is sent through the message egress information.

In this embodiment, if the current message is the plain message, the message is accelerated through the protocol stack standard in the hardware, achieving the processing of the plain message, and the performance is completely unaffected.

As an example, the selecting the corresponding acceleration processing strategy according to the determination result, includes:
step S23, in response to that the determination result is an L2TP message, extracting the inner layer information of the L2TP message;
step S24, performing hardware acceleration matching on the inner layer information according to the second matching rule; and
step S25, in response to that the match is successful, determining the hardware acceleration rule corresponding to the inner layer information, and modifying and forwarding the L2TP message according to the hardware acceleration rule.

As an example, if the current message that needs hardware acceleration is determined to be an L2TP type message, that is, an L2TP message, according to the first matching rule, it is necessary to match the inner layer information of the L2TP message according to the second matching rule, and give the hardware acceleration rule of the L2TP message.

As an example, if the current message is an L2TP message, the inner information of the L2TP message (such as the five-tuple of the inner layer message: inner layer source IP, inner layer destination IP, inner layer source port number, inner layer destination port number, inner layer protocol number) is extracted. Based on the second matching rule, the hardware performs a secondary matching on the L2TP message according to the hardware algorithm to determine whether the same acceleration rule can be found, that is, whether the hardware acceleration rule corresponding to the L2TP message is matched.

As an example, if the second matching rule matches successfully, that is, the hardware acceleration rule corresponding to the L2TP message is matched, the L2TP message is modified and forwarded according to the information configured by the hardware acceleration rule protocol.

As an example, after performing hardware acceleration matching on the inner layer information according to the second matching rule, the method further includes:

step S26, in response to that the match is unsuccessful, sending the L2TP message to the kernel protocol stack, to allow the kernel protocol stack to modify and forward the L2TP message according to the protocol stack standard.

As an example, if the same hardware acceleration rule cannot be found according to the second matching rule, it means that the current L2TP message is a new L2TP message, and the protocol stack needs to identify and configure the rule. Therefore, the hardware is controlled to send the L2TP message to the kernel protocol stack, so that the kernel protocol stack can modify and forward the L2TP message that has not been matched successfully according to the protocol stack standard.

As an example, modifying and forwarding the L2TP message according to the hardware acceleration rule includes:
step S251, the hardware acceleration rule includes the packet modification rule and the message egress information, and modifying the L2TP message according to the packet modification rule to obtain a target rule, and the target rule is configured to determine whether the L2TP message needs hardware acceleration during message processing; and
step S252, updating the current egress information according to the message egress information, and forwarding the L2TP message through the message egress information.

As an example, the hardware acceleration rule includes packet modification rules and message egress information. The packet modification rules include deleting the outer layer IP header, modifying the source MAC, modifying the destination MAC, modifying the inner layer destination IP, etc. The message egress information includes information such as the egress port and queue.

As an example, if the second matching rule successfully matches the hardware acceleration rule of the L2TP message, the L2TP message is modified according to the packet modification rule in the hardware acceleration rule to obtain the target rule, which is used to determine whether the L2TP message needs hardware acceleration during message processing. After the packet modification is completed, the current egress information is updated according to the message egress information in the hardware acceleration rule (such as the destination port number, queue number, etc.), and the hardware sends the modified L2TP message according to the updated message egress information, thereby realizing the hardware acceleration function of the L2TP message.

As an example, before modifying the L2TP message according to the packet modification rule to obtain the target rule, the method further includes:
step S253, in response to that the L2TP message has an encapsulation header, decapsulating the L2TP message to obtain a processed plain message.

The modifying the L2TP message according to the packet modification rule to obtain the target rule includes:
step S2511, performing a packet modification operation on the processed plain message according to the packet modification rule to obtain the target rule.

As an example, if the L2TP message has an encapsulation header, the hardware first decapsulates the L2TP message according to the configured L2TP packet modification information, and remove the outer layer information (such as the outer layer IP, outer layer UDP, L2TP header and inner layer PPP header). In this way, the L2TP message becomes the plain message. Then, the inner layer of the L2TP message is modified, and the packet modification information includes IP information modification, VLAN addition, deletion or rewriting, source MAC destination MAC modification, and port number modification. After modifying the packet according to the hardware acceleration rule, the target rule is obtained, and then the message egress information in the hardware acceleration rule is updated, such as the destination port number, queue number and other information. The hardware sends the modified L2TP message according to the message egress information.

The embodiments of the present application provide a method, an apparatus and a device for performing hardware acceleration on an L2TP message, and a storage medium. Compared with the current difficulty in hardware acceleration of L2TP messages, in the embodiments of the present application, it is determined, according to the first matching rule, whether the current message that requires hardware acceleration is an L2TP type message, and the first matching rule is the protocol stack configuration information that is only used to identify the header type of the current message; the corresponding acceleration processing strategy is selected according to the determination result. When the determination result is the plain message of non-L2TP type, the acceleration processing is performed on the plain message according to the preset protocol stack standard. When the determination result is an L2TP message, the acceleration processing is performed on the L2TP message according to the second matching rule, and the second matching rule is the protocol stack configuration information for matching the inner layer information of the L2TP message. That is, by designing two sets of matching rules (first matching rule and second matching rule) for the hardware, when the hardware receives a message that requires hardware acceleration, the header of the current message is identified through the first matching rule to identify whether the current message is the L2TP message. If the current message is the L2TP message, based on the characteristic that the L2TP message has inner layer information, the protocol stack configuration information of the L2TP message is given through the second matching rule, and the acceleration processing (packet modification, forwarding) is performed for the inner layer information of the L2TP through the protocol stack configuration information, thereby realizing the hardware acceleration function of the L2TP message. At the same time, if the current message is the plain message of non-L2TP type, the acceleration processing (packet modification, forwarding) is performed on the plain message through the protocol stack standard of the kernel protocol stack, ensuring that the processing performance of plain messages is not affected. Therefore, by matching L2TP messages twice in the present application, hardware acceleration on the L2TP message is achieved without affecting the processing performance of plain messages. Compared with the processing performance of L2TP messages by the kernel protocol stack, the processing capability of L2TP messages is improved.

Based on the above-mentioned first embodiment of the method for performing hardware acceleration processing on the L2TP message, a second embodiment of the method is proposed.

Before determining, according to the first matching rule, whether the current message requiring hardware acceleration is an L2TP type message, the method further includes:
step A1, extracting the rule information of the current message, the rule information includes the five-tuple information of the current message;
step A2, determining, according to the rule information and the preset hardware acceleration rule, whether the current message is configured with hardware acceleration information;
step A3, for the current message configured with hardware acceleration information, determining, according to the first matching rule, whether the current message requiring hardware acceleration is an L2TP type message; and
step A4, for the current message not configured with hardware acceleration information, sending the current message to the kernel protocol stack for the kernel protocol stack to modify and forward the current message.

As an example, the rule information of the message includes five-tuple information, etc., and the five-tuple information includes source IP address, destination IP address, source port, destination port, and protocol number.

As an example, after receiving the current message, the hardware or hardware module in a system for performing hardware acceleration processing on the L2TP message extracts the rule information of the current message (such as the five-tuple: source IP address, destination IP address, source port, destination port, protocol number, etc.), matches the rule information of the current message according to the hardware algorithm, and determines whether the same hardware acceleration rule is found. In other words, it identifies whether the current message has been configured with hardware acceleration information.

As an example, if the rule information of the current message is matched according to the hardware algorithm and the same hardware acceleration rule is found, it is determined that the current message is configured with hardware acceleration information, and the step of determining whether the current message requiring hardware acceleration is an L2TP type message according to the first matching rule is performed. According to the hardware acceleration rule or hardware acceleration information of the current message, the type of the current message configured with hardware acceleration information is identified to determine whether it is an L2TP message.

As an example, if the rule information of the current message is matched according to the hardware algorithm and the same hardware acceleration rule is not found, it is determined that the current message is not configured with hardware acceleration information, and the current message not configured with hardware acceleration information is sent to the kernel protocol stack for processing.

As an example, after receiving the current message, the kernel protocol stack processes the current message according to the protocol configured by the kernel protocol stack, such as message parsing, modification, and forwarding.

As an example, the modification process refers to modifying the source MAC, destination MAC, destination IP, adding VLAN, etc. of the current message. As an example, the protocol configured by the kernel protocol stack includes message egress information, such as egress port, queue, etc. The current message is forwarded according to the message egress information.

Based on the above-mentioned first embodiment or the second embodiment of the method for performing hardware acceleration processing on the L2TP message, a third embodiment of the method is proposed.

As an example, for a current message that is not configured with hardware acceleration information, sending the current message to the kernel protocol stack to enable the kernel protocol stack to modify and forward the current message includes:
step A41, in response to that the kernel protocol stack processes the current message, determining whether the current message meets the hardware acceleration condition; and
step A42, in response to that the current message meets the hardware acceleration condition, controlling the kernel protocol stack to issue the hardware acceleration rule of the current message to the hardware, to enable the hardware to determine, upon processing the message, whether to perform hardware acceleration processing on the current message.

As an example, after the kernel protocol stack receives a message that is not configured with hardware acceleration information, it will parse, modify, and forward the message according to the protocol of the kernel protocol stack. When the kernel protocol stack recognizes that the current message meets the hardware acceleration conditions, that is, the current message needs to generate hardware acceleration, the kernel protocol stack will send hardware acceleration procedures/hardware acceleration rules to the hardware. After receiving the message, based on the rule information of the current message, if the same hardware acceleration rules are matched, the hardware will modify the message according to the packet modification rules in the hardware acceleration rules, and then forward the message according to the message egress information in the hardware acceleration rules. In this way, the message implements the hardware acceleration function without passing through the protocol stack. The message forwarding performance is greatly improved.

As an example, the hardware acceleration condition includes that the number of messages received within a preset time that have the same pattern as the current message exceeds the number threshold. For example, more than 10 L2TP messages with the same pattern are received within 1 second.

As an example, the hardware acceleration rules sent to the hardware by the kernel protocol stack include the first matching rule and the second matching rule. The first matching rule is used to identify whether the current message is an L2TP encapsulated message, and the second matching rule is used to give the packet modification information and egress information of the L2TP message. This not only ensures that the processing performance of plain messages is not affected, but also realizes the hardware acceleration function on the L2TP message, improving the chip's processing ability for L2TP messages and the competitiveness of the chip.

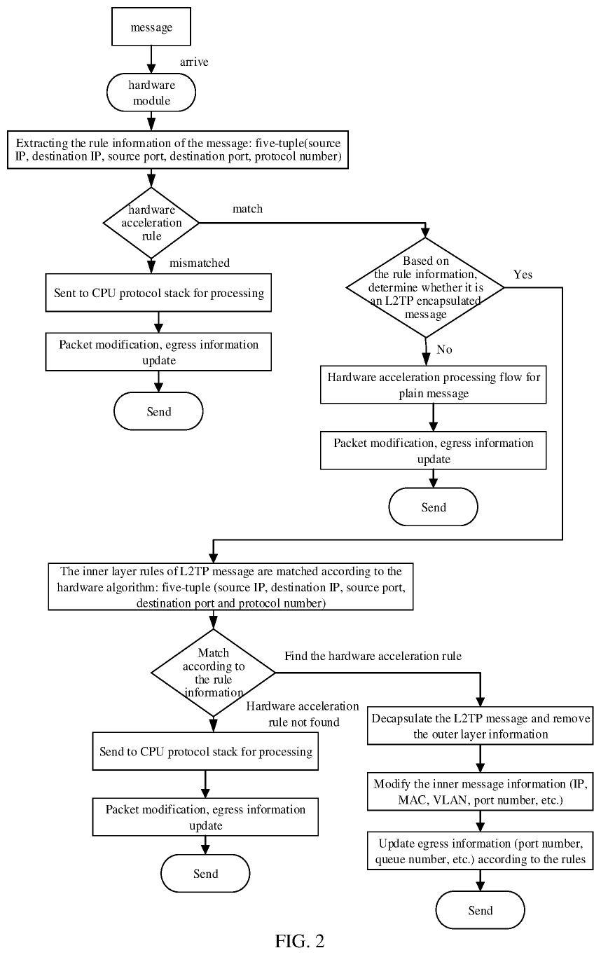

The hardware processing flow in some scenarios is described in detail below with reference to FIG. 2.
Step 1, after receiving the current message, extracting, via the hardware/hardware module, the rule information of the current message (such as the five-tuple: source IP address, destination IP address, source port, destination port, protocol number, etc.).
Step 2, performing, via the hardware, matching using the rule information according to the hardware algorithm to determine whether the current message is configured with hardware acceleration information or whether the same hardware acceleration rule can be found. If the same hardware acceleration rule is found, proceed to step 3.

If the same hardware acceleration rule cannot be found, the current message is sent to the CPU protocol stack (i.e., the kernel protocol stack) for processing. The kernel protocol stack modifies the current message and updates the egress information. After the modified current message is forwarded based on the egress information, the process ends.
Step 3, after finding the same hardware acceleration rule, based on the rule information of the current message, determining, via the hardware, the current message according to the configuration information of the first matching rule to determine whether the current message is an L2TP encapsulated message or an L2TP message.
Step 3.1, in response to that the current message is not an L2TP encapsulated message, that is, the plain message, processing, via the hardware, the current message as the plain message. (The hardware modifies the message according to the configured packet modification information; according to the message egress information, the modified message is sent).
Step 3.2, if the current message is an L2TP encapsulated message, the hardware needs to match the inner layer rule of the L2TP message (that is, the second matching rule).
Step 3.3, the hardware extracts the inner layer information of the message (such as the inner layer source IP, inner layer destination IP, inner layer source port number, inner layer destination port number, inner layer protocol number).
Step 3.4, the hardware matches the inner layer information of the L2TP message according to the hardware algorithm through the second matching rule to find the same hardware acceleration rule. (If the same hardware acceleration rule cannot be found, the L2TP message is sent to the CPU protocol stack for processing, and the kernel protocol stack modifies the current message and updates the egress information. After the modified current message is forwarded based on the egress information, the process ends.
Step 3.5, the hardware first decapsulates the L2TP message according to the packet modification information of the L2TP message configured by the hardware acceleration rule, and remove the outer layer information (outer layer IP, outer layer UDP, L2TP header and inner layer PPP header) to become the normal message. Then, the inner layer message is modified, and the packet modification information includes IP information modification, vlan addition, deletion or rewriting, source mac destination mac modification, and port number modification. After modifying the packet according to the hardware acceleration rule, the egress information in the rule is updated, such as the destination port number, queue number and other information.
Step 3.6, the hardware sends the modified L2TP message according to the message egress information.

It should be noted that this solution can also be extended to VXLAN, DSLITE and other encapsulated message scenarios.

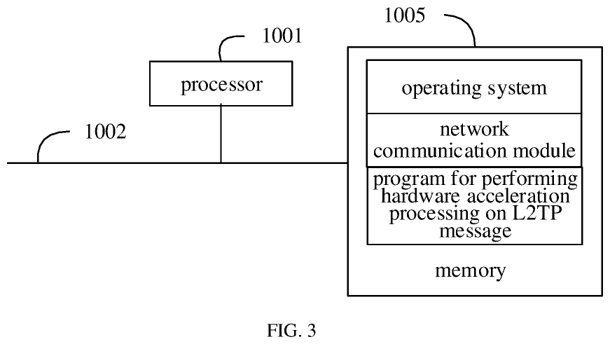

Referring to FIG. 3, FIG. 3 is a schematic structural diagram of the hardware operating environment according to an embodiment of the present disclosure.

As shown in FIG. 3, a hardware acceleration device for L2TP messages can include: a processor 1001, a memory 1005, and a communication bus 1002. The communication bus 1002 is configured to implement the connection communication between the processor 1001 and the memory 1005.

In an embodiment, the hardware acceleration device for L2TP messages can also include a user interface, a network interface, a camera, a radio frequency (RF) circuit, a sensor, a WiFi module, and the like. The user interface can include a display, an input submodule such as a keyboard. The user interface can also include a standard wired interface and a wireless interface. The network interface can include a standard wired interface and a wireless interface (such as a WI-FI interface).

Those skilled in the art can understand that the structure of the device for performing hardware acceleration processing on the L2TP message shown in FIG. 3 does not constitute a limitation on the device, and can include more or fewer components than shown in the figure, or combinations of certain components, or differently arranged components.

As shown in FIG. 3, the memory 1005 as a storage medium can include an operating system, a network communication module, and a program for performing hardware acceleration processing on the L2TP message. The operating system is a program that manages and controls the hardware and software resources of the device for performing hardware acceleration processing on the L2TP message, and supports operation of the program for performing hardware acceleration processing on the L2TP message and other software and/or programs. The network communication module is configured to implement the communication between the components inside the memory 1005, and to communicate with other hardware and software in the system for performing hardware acceleration processing on the L2TP message.

In the device for performing hardware acceleration processing on the L2TP message shown in FIG. 3, the processor 1001 is configured to execute the program for performing hardware acceleration processing on the L2TP message stored in the memory 1005 to implement the method for performing hardware acceleration processing on the L2TP message as described above.

The specific implementation of the device for performing hardware acceleration processing on the L2TP message in the present application is basically the same as the above-mentioned embodiments of the method for performing hardware acceleration processing on the L2TP message, and will not be repeated here.

The embodiment of the present application also provides an apparatus for performing hardware acceleration processing on the L2TP message, which includes an identification module and an acceleration module.

The identification module is configured to determine whether the current message requiring hardware acceleration is an L2TP type message according to the first matching rule. The first matching rule is protocol stack configuration information used only to identify the header type of the current message.

The acceleration module is configured to select a corresponding acceleration processing strategy according to the determination result. When the determination result is a plain message of a non-L2TP type, the acceleration processing is performed on the plain message according to a preset protocol stack standard. When the determination result is an L2TP message, the acceleration processing is performed on the L2TP message according to the second matching rule. The second matching rule is protocol stack configuration information used to match the inner layer information of the L2TP message.

In an embodiment of the present application, the acceleration module further includes an information extraction submodule, a matching submodule and a first acceleration processing submodule.

The information extraction submodule is configured to extract the inner layer information of the L2TP message if the determination result is the L2TP message.

The matching submodule is configured to perform hardware acceleration matching on the inner layer information according to the second matching rule.

The first acceleration processing submodule is configured to determine the hardware acceleration rule corresponding to the inner layer information when the match is successful, and modify and forward the L2TP message according to the hardware acceleration rule.

And/or, the acceleration processing submodule further includes a modification processing unit and a forwarding processing unit.

The modification processing unit is configured to perform a packet modification operation on the L2TP message according to the packet modification rule to obtain a target rule, where the hardware acceleration rule includes a packet modification rule and a message egress information, and the target rule is configured to determine whether hardware acceleration is required for the L2TP message during message processing;

The forwarding processing unit is configured to update the current egress information according to the message egress information, and forward the L2TP message through the message egress information.

And/or, the acceleration processing submodule further includes a decapsulation unit.

The decapsulation unit is configured to decapsulate the L2TP message if the L2TP message has an encapsulation header to obtain a processed plain message.

And/or, the modification processing unit further includes a modification processing sub-unit.

The modification processing sub-unit is configured to perform a packet modification operation on the processed plain message according to the packet modification rule to obtain a target rule.

And/or, the acceleration module also includes a second acceleration processing submodule.

The second acceleration processing submodule is configured to send the L2TP message to the kernel protocol stack when the match is unsuccessful, to allow the kernel protocol stack to modify and forward the L2TP message according to the protocol stack standard.

And/or, the acceleration module also includes an information acquisition submodule and a message processing submodule.

The information acquisition submodule is configured to obtain the protocol stack standard configured in the hardware if the determination result is a plain message of non-L2TP type.

The message processing submodule is configured to modify and forward the plain message according to the protocol stack standard.

And/or, the apparatus further includes an information extraction module, an information determination module, a first processing module and a second processing module.

The information extraction module is configured to extract rule information of the current message. The rule information includes five-tuple information of the current message.

The information determination module is configured to determine whether the current message is configured with hardware acceleration information according to the rule information and the preset hardware acceleration rule;

The first processing module is configured to determine whether the current message requiring hardware acceleration is an L2TP type message according to the first matching rule for the current message configured with hardware acceleration information.

The second processing module is configured to send the current message to the kernel protocol stack for the current message not configured with hardware acceleration information, to allow the kernel protocol stack to modify and forward the current message.

The specific implementation of the apparatus for performing hardware acceleration on the L2TP message in the present application is basically the same as the various embodiments of the method for performing hardware acceleration on the 2TP message described above, and will not be repeated here.

The embodiment of the present application provides a computer-readable storage medium, and the computer-readable storage medium stores one or more programs, and the one or more programs can also be executed by one or more processors to implement the method for performing hardware acceleration on the L2TP message as described above.

The specific implementation of the storage medium in the present application is basically the same as the various embodiments of the method for performing hardware acceleration on the L2TP message as described above, and will not be repeated here.

The present application also provides a computer program product, including a computer program, which implements the above-mentioned method for performing hardware acceleration on the L2TP message when executed by a processor.

The specific implementation of the computer program product of the present application is basically the same as the above-mentioned method for performing hardware acceleration on the L2TP message, and will not be repeated here.

It should be noted that, in this article, the terms “include”, “comprises” or any other variations thereof are intended to cover non-exclusive inclusion, so that a process, method, article or device including a series of elements includes not only those elements, but also includes other elements not explicitly listed, or also includes elements inherent to such process, method, article or device. In the absence of further restrictions, an element defined by the sentence “include a . . . ” does not exclude the existence of other identical elements in the process, method, article or device including the element.

The serial numbers of the above embodiments of the present application are only for description and do not represent the advantages and disadvantages of the embodiments.

Through the description of the above embodiments, those skilled in the art can clearly understand that the above embodiment methods can be implemented by software plus hardware platform, or by hardware, but in many cases the former is better. Based on this understanding, the technical solution of the present application, essentially or the part that contributes to the related art, can be embodied in the form of a software product, which is stored in a storage medium (such as ROM/RAM, disk, CD), including several instructions for a terminal device (which can be a mobile phone, computer, server, air conditioner, or network device, etc.) to execute the methods described in each embodiment of the present application.

The above are only some embodiments of the present application, and are not intended to limit the scope of the present application. Any equivalent structural transformation or equivalent process transformation made using the contents of the specification and drawings of the present application, or directly or indirectly applied in other related technical fields, are also included in the scope of the present application.

1. A method for performing hardware acceleration on a layer 2 tunneling protocol (L2TP) message, comprising:
determining whether a current message requiring hardware acceleration is an L2TP type message according to a first matching rule, wherein the first matching rule is protocol stack configuration information used only to identify a header type of the current message; and
selecting a corresponding acceleration processing strategy according to a determination result, in response to that the determination result is a plain message of a non-L2TP type, performing acceleration processing on the plain message according to a preset protocol stack standard, and in response to that the determination result is an L2TP message, performing acceleration processing on the L2TP message according to a second matching rule, wherein the second matching rule is protocol stack configuration information for matching inner layer information of the L2TP message.

2. The method for performing hardware acceleration on the L2TP message of claim 1, wherein the selecting the corresponding acceleration processing strategy according to the determination result comprises:
in response to that the determination result is the L2TP message, extracting the inner layer information of the L2TP message;
performing hardware acceleration matching on the inner layer information according to the second matching rule; and
in response to that the hardware acceleration matching is successful, determining a hardware acceleration rule corresponding to the inner layer information, and modifying and forwarding the L2TP message according to the hardware acceleration rule.

3. The method for performing hardware acceleration on the L2TP message of claim 2, wherein the modifying and forwarding the L2TP message according to the hardware acceleration rule comprises:
the hardware acceleration rule comprises a packet modification rule and message egress information; performing a packet modification operation on the L2TP message according to the packet modification rule to obtain a target rule, wherein the target rule is configured to determine whether hardware acceleration is required for the L2TP message during message processing; and
updating current egress information according to the message egress information, and forwarding the L2TP message through the message egress information.

4. The method for performing hardware acceleration on the L2TP message of claim 3, wherein before the performing the packet modification operation on the L2TP message according to the packet modification rule to obtain the target rule, the method further comprises:
in response to that the L2TP message has an encapsulation header, decapsulating the L2TP message to obtain a processed plain message;
the performing the packet modification operation on the L2TP message according to the packet modification rule to obtain the target rule comprises:
performing the packet modification operation on the processed plain message according to the packet modification rule to obtain the target rule.

5. The method for performing hardware acceleration on the L2TP message of claim 2, wherein after the performing the hardware acceleration matching on the inner layer information according to the second matching rule, the method further comprises:
in response to that the hardware acceleration matching is unsuccessful, sending the L2TP message to a kernel protocol stack, to allow the kernel protocol stack to modify and forward the L2TP message according to the protocol stack standard.

6. The method for performing hardware acceleration on the L2TP message of claim 1, wherein the selecting the corresponding acceleration processing strategy according to the determination result comprises:
in response to that the determination result is a plain message of a non-L2TP type, obtaining protocol stack standard configured in the hardware; and
modifying and forwarding the plain message according to the protocol stack standard.

7. The method for performing hardware acceleration on the L2TP message of claim 1, wherein before the determining whether the current message requiring hardware acceleration is the L2TP type message according to the first matching rule, the method further comprises:
extracting rule information of the current message, wherein the rule information comprises five-tuple information of the current message;
determining whether the current message is configured with hardware acceleration information according to the rule information and a preset hardware acceleration rule;
for the current message configured with the hardware acceleration information, determining whether the current message requiring hardware acceleration is the L2TP type message according to the first matching rule; and
for the current message not configured with the hardware acceleration information, sending the current message to a kernel protocol stack to allow the kernel protocol stack to modify and forward the current message.

8. (canceled)

9. A device for performing hardware acceleration on a layer 2 tunneling protocol (L2TP) message, comprising: a memory, a processor, and a program for performing hardware acceleration on the L2TP message stored in the memory and executable on the processor, wherein when the program for performing hardware acceleration on the L2TP message is executed by the processor, a method for performing hardware acceleration on the L2TP message is implemented, the method for performing hardware acceleration on the L2TP message comprising:
determining whether a current message requiring hardware acceleration is an L2TP type message according to a first matching rule, wherein the first matching rule is protocol stack configuration information used only to identify a header type of the current message; and
selecting a corresponding acceleration processing strategy according to a determination result, in response to that the determination result is a plain message of a non-L2TP type, performing acceleration processing on the plain message according to a preset protocol stack standard, and in response to that the determination result is an L2TP message, performing acceleration processing on the L2TP message according to a second matching rule, wherein the second matching rule is protocol stack configuration information for matching inner layer information of the L2TP message.

10. A non-transitory computer-readable storage medium, wherein a program for performing hardware acceleration on a layer 2 tunneling protocol (L2TP) message is stored on the non-transitory computer-readable storage medium, and when the program for performing hardware acceleration on the L2TP message is executed by a processor, the method for performing hardware acceleration on the L2TP message of claim 1 is implemented.

11. The device for performing hardware acceleration on the L2TP message of claim 9, wherein the program for performing hardware acceleration on the L2TP message, when executed by the processor, is configured to:
in response to that the determination result is the L2TP message, extract the inner layer information of the L2TP message;
perform hardware acceleration matching on the inner layer information according to the second matching rule; and
in response to that the hardware acceleration matching is successful, determine a hardware acceleration rule corresponding to the inner layer information, and modifying and forwarding the L2TP message according to the hardware acceleration rule.

12. The device for performing hardware acceleration on the L2TP message of claim 11, wherein the hardware acceleration rule comprises a packet modification rule and message egress information, and the program for performing hardware acceleration on the L2TP message, when executed by the processor, is configured to:
perform a packet modification operation on the L2TP message according to the packet modification rule to obtain a target rule, wherein the target rule is configured to determine whether hardware acceleration is required for the L2TP message during message processing; and
update current egress information according to the message egress information, and forward the L2TP message through the message egress information.

13. The device for performing hardware acceleration on the L2TP message of claim 12, wherein the program for performing hardware acceleration on the L2TP message, when executed by the processor, is configured to perform the packet modification operation on the processed plain message according to the packet modification rule to obtain the target rule, and before performing the packet modification operation on the L2TP message according to the packet modification rule to obtain the target rule, in response to that the L2TP message has an encapsulation header, decapsulate the L2TP message to obtain a processed plain message.

14. The device for performing hardware acceleration on the L2TP message of claim 11, wherein after performing the hardware acceleration matching on the inner layer information according to the second matching rule, the program for performing hardware acceleration on the L2TP message, when executed by the processor, is configured to:
in response to that the hardware acceleration matching is unsuccessful, send the L2TP message to a kernel protocol stack, to allow the kernel protocol stack to modify and forward the L2TP message according to the protocol stack standard.

15. The device for performing hardware acceleration on the L2TP message of claim 9, wherein the program for performing hardware acceleration on the L2TP message, when executed by the processor, is configured to:
in response to that the determination result is a plain message of a non-L2TP type, obtain protocol stack standard configured in the hardware; and
modify and forward the plain message according to the protocol stack standard.

16. The device for performing hardware acceleration on the L2TP message of claim 9, wherein before determining whether the current message requiring hardware acceleration is the L2TP type message according to the first matching rule, the program for performing hardware acceleration on the L2TP message, when executed by the processor, is configured to:
extract rule information of the current message, wherein the rule information comprises five-tuple information of the current message;
determine whether the current message is configured with hardware acceleration information according to the rule information and a preset hardware acceleration rule;
for the current message configured with the hardware acceleration information, determine whether the current message requiring hardware acceleration is the L2TP type message according to the first matching rule; and
for the current message not configured with the hardware acceleration information, send the current message to a kernel protocol stack to allow the kernel protocol stack to modify and forward the current message.
